(19) United States
(12) Patent Application Publication
(10) Pub. No.: US 2019/0379962 A1
(43) Pub. Date: Dec. 12, 2019

(54) VENTING HEADPHONES

(71) Applicant: dreamGEAR, LLC, Torrance, CA (US)

(72) Inventor: Amir Navid, Sherman Oaks, CA (US)

(21) Appl. No.: 16/428,920

(22) Filed: May 31, 2019

Related U.S. Application Data
(60) Provisional application No. 62/682,806, filed on Jun. 8, 2018.

(51) Int. Cl. H04R 1/10; H04R 1/38; H04R 1/28

(52) U.S. Cl. CPC H04R 1/1008; H04R 1/1083; H04R 2460/11; H04R 1/2823; H04R 1/38

(57) ABSTRACT

Full ear covering venting audio headphones with a pair of ear cups. The ear cups have an ear cup shell portion with venting window formed in a sidewall thereof, ear cushions, a speaker, and a vent carrier rotatably positioned relative to the sidewall of the ear cup shell portion. The vent carrier has windows and the vent carrier is rotatable between a closed position where the vent carrier window are out of alignment with the venting window to thereby block the venting window on the ear cup shell portion, and an opened position, where the vent carrier windows are aligned with the venting windows to thereby unblock and expose the venting windows on the ear cup shell portion to allow air and sound to pass into the ear cup shells and to allow moisture and heat to better escape therefrom.

### CROSS-REFERENCE TO RELATED APPLICATION

This application claims priority of U.S. Provisional Patent Application No. 62/682,806 filed on Jun. 8, 2018, entitled VENTING HEADPHONES,” the entire contents of which are hereby incorporated herein by reference.

### FIELD OF THE INVENTION

The present disclosure relates to the field of headphones, and more particularly to headphones with ear cups that envelop the user's ears with the ear cups including vents that can be moved between a closed position and an open position, and even more particular to audio headphones with ear cups that envelop the user's ears with the ear cups including vents that can be moved between a closed position and an open position to selectively allow a user to both adjust how much sound from outside of the headphones will be allowed to reach the user's ears and/or to also allow for improved air circulation and cooling around a user's ears.

### BACKGROUND OF THE INVENTION

Audio headphones are widely used in a variety of application, including in listening to audio signals, including listening to music, watching movies, and playing computer games to list just a few. In the case of sound cancelation headphones, they can block out outside ambient noises by providing a good seal around the user's ears and the headphone's ear cups and/or by generating audio signals that cancel out some of the ambient sounds, e.g., the background noises when flying on aircraft, working in a loud workplace, etc. Audio headphones with ear cups that fully cover the user's ears (“full ear covering headphones” or “closed headphones”) provide an advantage of blocking out some outside noises and keeping the sounds emanating from the speakers inside each ear cup from being heard and/or from disturbing others. In cases of headphones without speakers, such as for working in loud environments, it is critical that a good sound seal be established between the headphones and the user's head and ears to block out noise. Closed audio headphones isolate the user from the noise around him or her and keep others from hearing sounds emanating from the speakers in the headphones and have some advantage when using headphones with a microphone in gaming as the sound emanating from the speakers in the ear shells will not be picked up by the microphone, e.g., on a boom connected to the headset. On the other hand, headphones that do not seal around the ears (“open headphones”) often produce better sound, but at the expense of sound passing through the cups. Moreover, open headphones are not always ideal for gaming because they do not prevent sound emanating from the speakers in the ear shells from being picked up by the microphone.

One problem sometimes encountered when wearing full ear covering headphones is that the user's ears become hot and sweaty with extended wear. This requires completely removing the full ear covering headphones from the user's head, or at least temporarily lifting the ear cups away from the ears to let them cool and dry off. It can be a problem to have to stop and do this when in the middle of an activity, such as a gaming competition or during taxing workplace tasks. Yet another problem with full ear covering headphones is that sometimes user's need to be able to hear background voices and sounds and if the seal between the ear cups and the user's head is too good, the user cannot hear outside voices and sounds, such as someone calling out to try to communicate with the user, or important background sounds and noises, e.g., alarms, etc.

There accordingly remains a need for full ear covering headphones that addresses the problems of overheating and sweating ears and also the problem of selectively not being able to hear important background sounds and noises when desired.

### BRIEF DESCRIPTION OF THE DRAWINGS

FIG. 1 is a is top front right isometric view showing an exemplary embodiment of venting headphones of the invention with a headband with a cushion and with the venting windows on the ear cup portions shown in their closed position, and with its optional microphone boom engaged to the right ear cup portion.

FIG. 2 is front view showing the venting headphone of FIG. 1.

FIG. 3 is a rear view showing the venting headphone of FIG. 1.

FIG. 4 is a right side view showing the venting headphone of FIG. 1.

FIG. 5 is a left side view showing the venting headphone of FIG. 1.

FIG. 6 is a top view showing the venting headphone of FIG. 1.

FIG. 7 is bottom view showing the venting headphone of FIG. 1.

FIG. 8 is top front right isometric view of the first venting headphones of FIG. 1 but showing the venting windows in their fully opened position.

FIG. 9 is front view showing the venting headphones of FIG. 8.

FIG. 10 is a rear view showing the venting headphones of FIG. 8.

FIG. 11 is an exploded view showing the ear cup shell, an interface piece, and the vent carrier of the ear cup portion of the venting headphones of FIG. 1.

FIG. 12 is an isometric view showing an ear cup portion of the venting headphones of FIG. 1 with its venting carrier in a closed position.

FIG. 13 is an isometric view showing an ear cup portion of the venting headphones of FIG. 1 with its venting carrier in a partially opened position.

FIG. 14 is an isometric view showing an ear cup portion of the venting headphones of FIG. 1 with its venting carrier in a completely opened position.

FIG. 15 is a cross sectional view through view lines 15-15 of the ear cup portion of the venting headphones of FIG. 12.

FIG. 16 is a detail of the dashed circled area of the ear cup portion of the venting headphones of FIG. 15.

### DETAILED DESCRIPTION

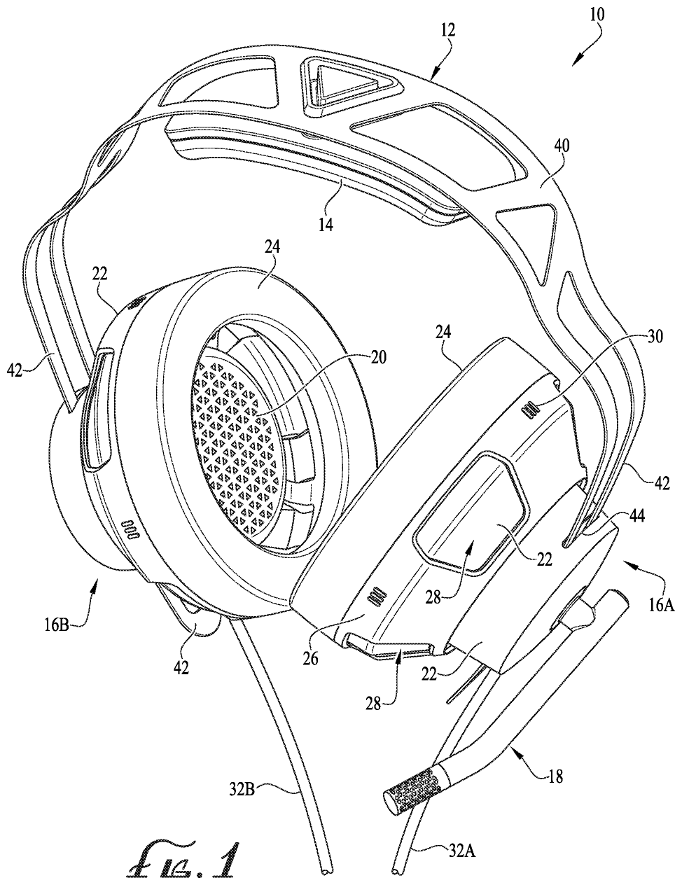

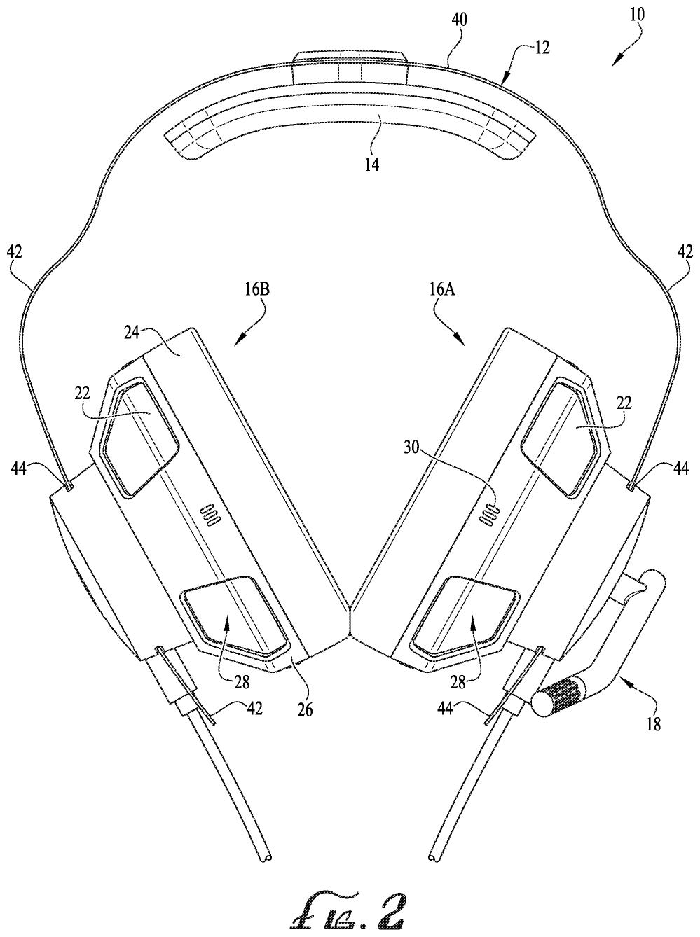

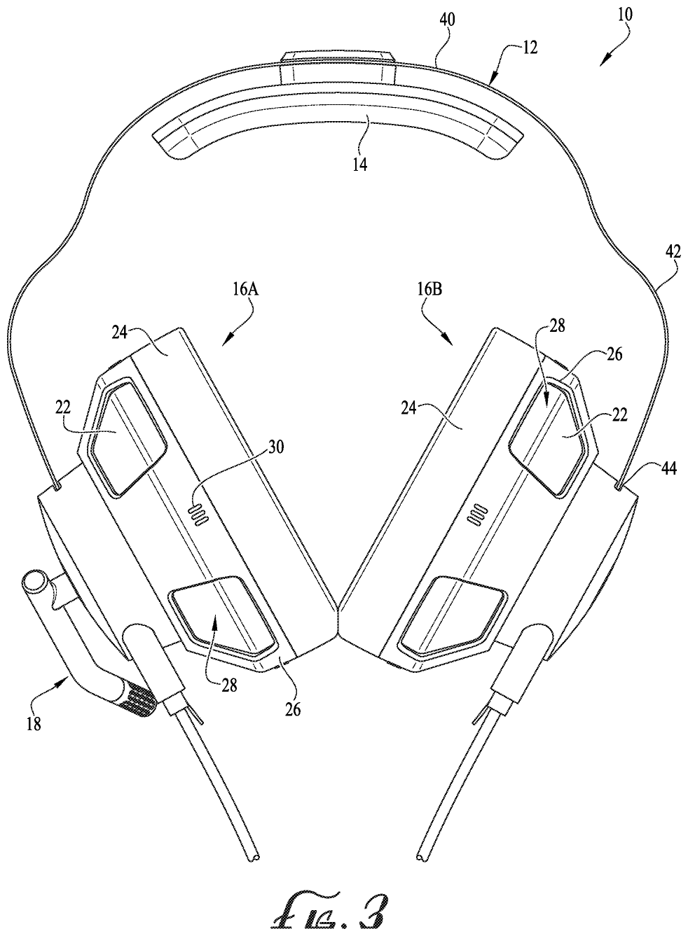

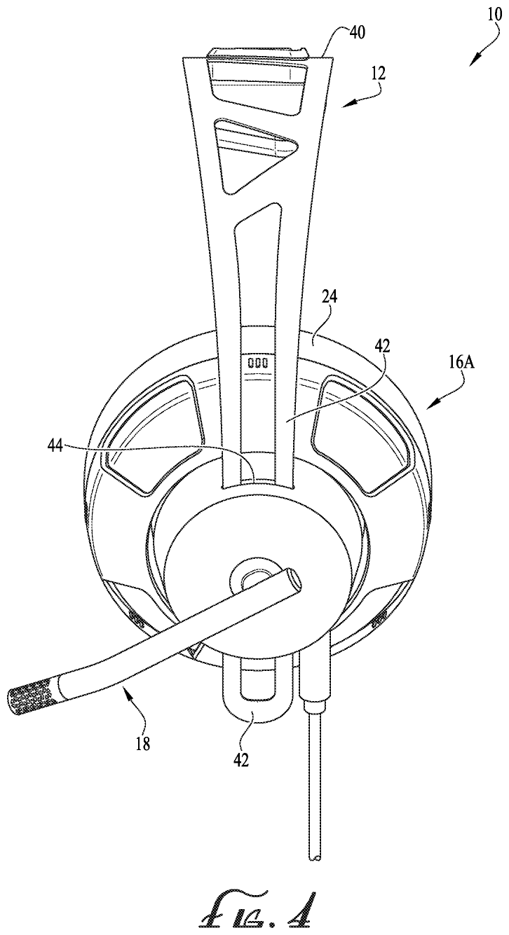

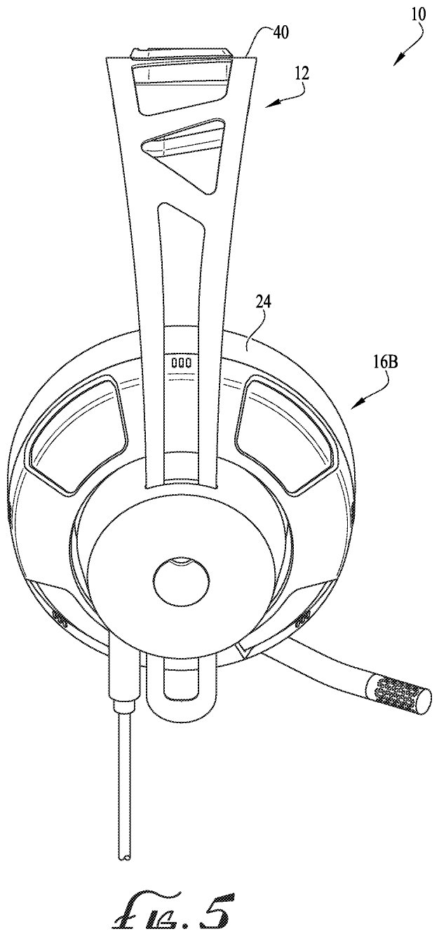

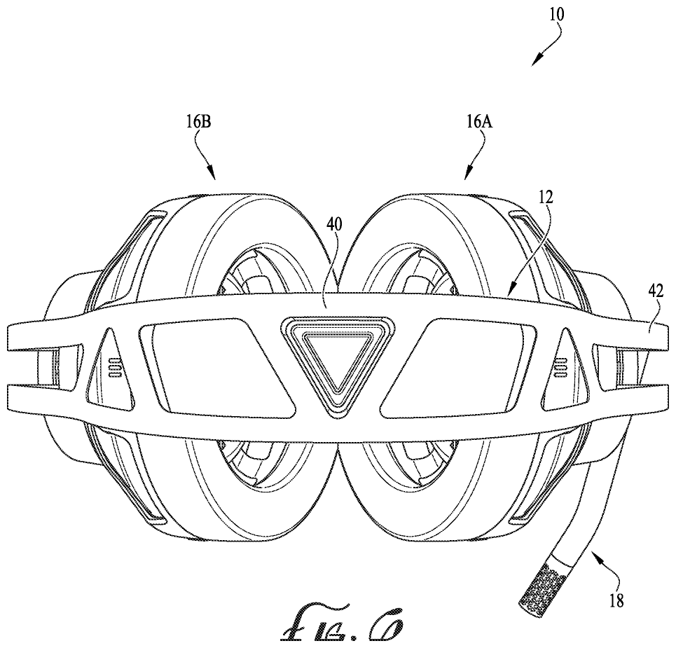

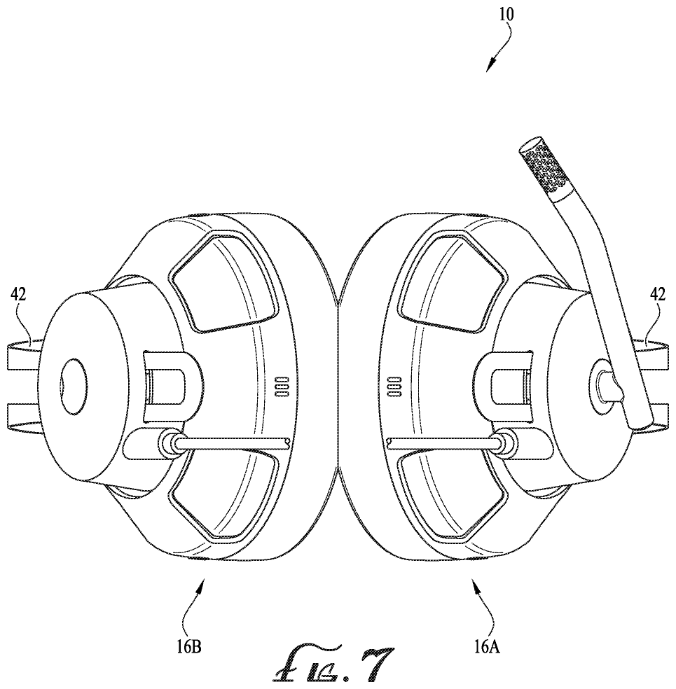

FIG. 1 is a is top front right isometric view, FIGS. 2 and 3 are respectively a front and rear view, FIG. 4 is a right side view, FIG. 5 is a left side view, FIG. 6 is a top view, and FIG. 7 is a bottom view showing an exemplary embodiment of venting headphones 10 of the invention with a headband 12 with a cushion 14, a pair of ear cup portions 16A and 16B, and an optional microphone boom 18 that selective engages with either of the ear cup portions 16A and 16B. A speaker 20 is located in an ear cup shell portion 22. An ear cushion 24 is preferably present to provide a comfortable and sound proofing seal between each ear cup portion 16A and 16B and a user's head (not shown). In the exemplary embodiment, movably connected to each ear cup shell portion 22 is a vent carrier 26 with at least one and preferably a plurality of vent carrier windows 28. If desired, grips 30 can be formed on the vent carrier 26 to aid in turning the vent carrier 26 relative to the ear cup shell portion 22. Audio signal/power cords 32A and 32B feed into each ear cup portions 16A and 16B. In the case of wireless venting headphones, such audio signal/power cords 32A and 32B would not be present, and the audio signal/power cords 32A and 32B are accordingly shown in phantom in FIGS. 2-5 and 7-10 below. In the exemplary embodiment of the venting headphones 10, the headband 12 will preferably have an upper portion 40 with the cushion 14 extending downwardly below, and two arm extension 42 that pass through slots 44 formed in the ear cup portions 16A and 16B and allow the ear cup portions 16A and 16B to be adjusted up and down as desired. Other structures can be used to provide for position adjustment of the ear cup portions 16A and 16B relative to the headband 12.

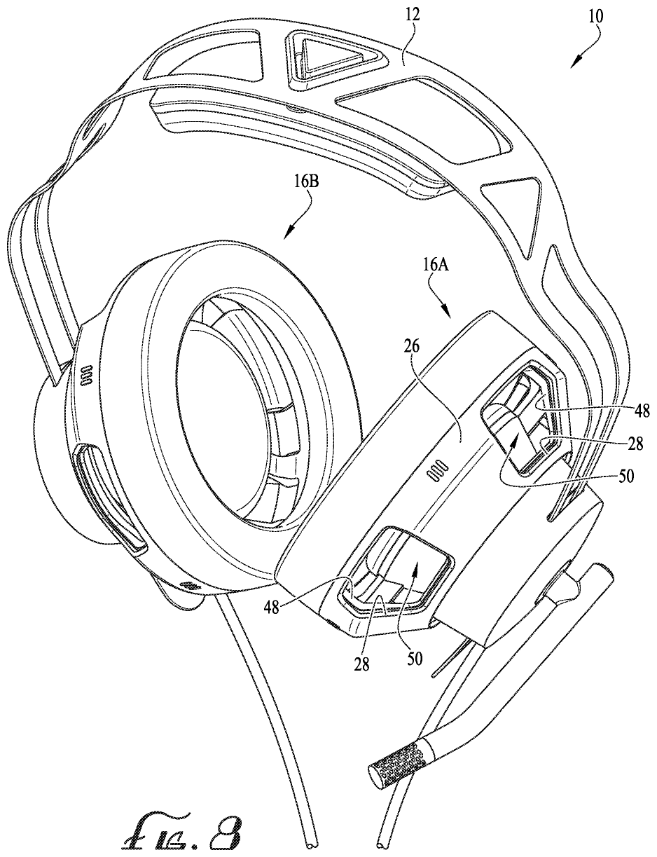

FIG. 8 is top front right isometric view showing the first venting headphones 10 of FIG. 1 but showing the vent carrier 26 with its plurality of vent carrier windows 28 rotated so that the vent carrier windows 28 are aligned with corresponding venting windows 48 formed in the ear cup shell portion 22. When aligned as such, this allows sound, air, heat, and moisture to pass through the new openings 50 in ear cup portions 16A and 16B without the user needing to remove the headphones 10 or pull them away from his or her head. Moreover, by rotating the vent carrier 26, this can likewise create different aural effects For instance, when the windows 50 are closed, the headphone will be a standard closed/isolated monitor headphone. But when the windows 50 are open, the headphone becomes open design headphones, which allow a more natural reference and added clarity for certain sounds. This state also allows the headphone users to hear other sounds in the room, so users who need to hear someone or something in the room can listen without removing the venting headphone 10. In intermediate states of openness of the windows 50, there would be a blending of isolated and open sounds qualities.

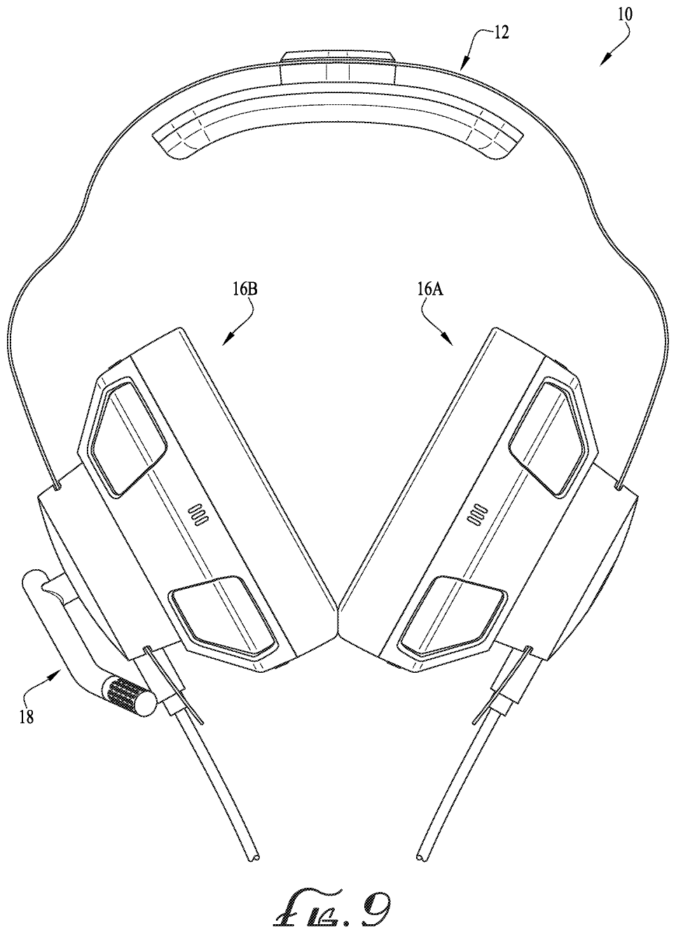

FIG. 9 is front view showing the venting headphones 10 of FIG. 1 but with the optional microphone boom 18 moved over for the ear cup portion 16A to the ear cup portion 16B.

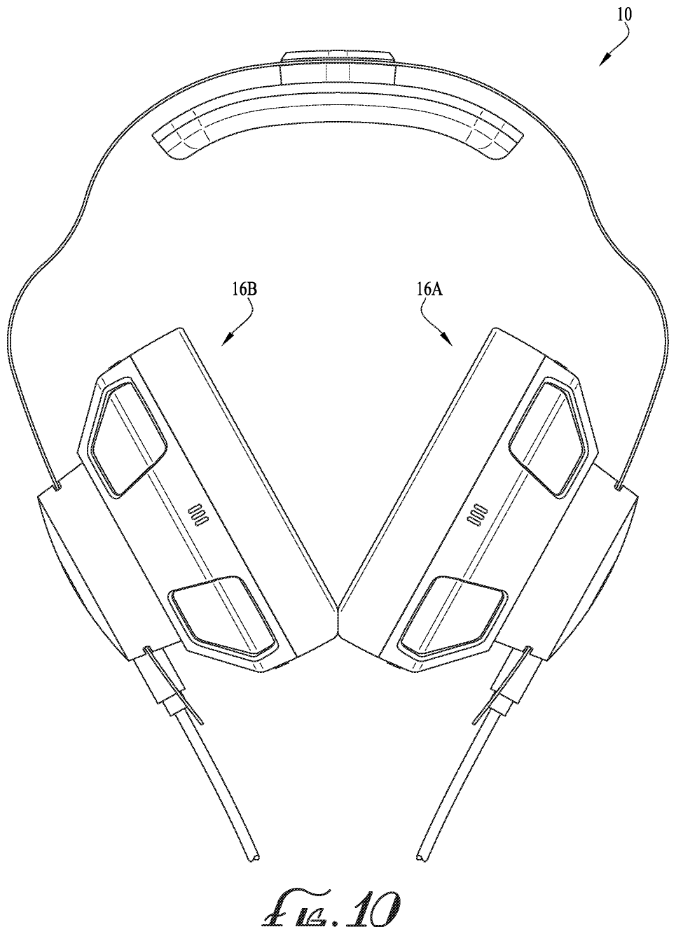

FIG. 10 is a rear view showing the venting headphones 10 of FIG. 1 without an optional microphone boom in use.

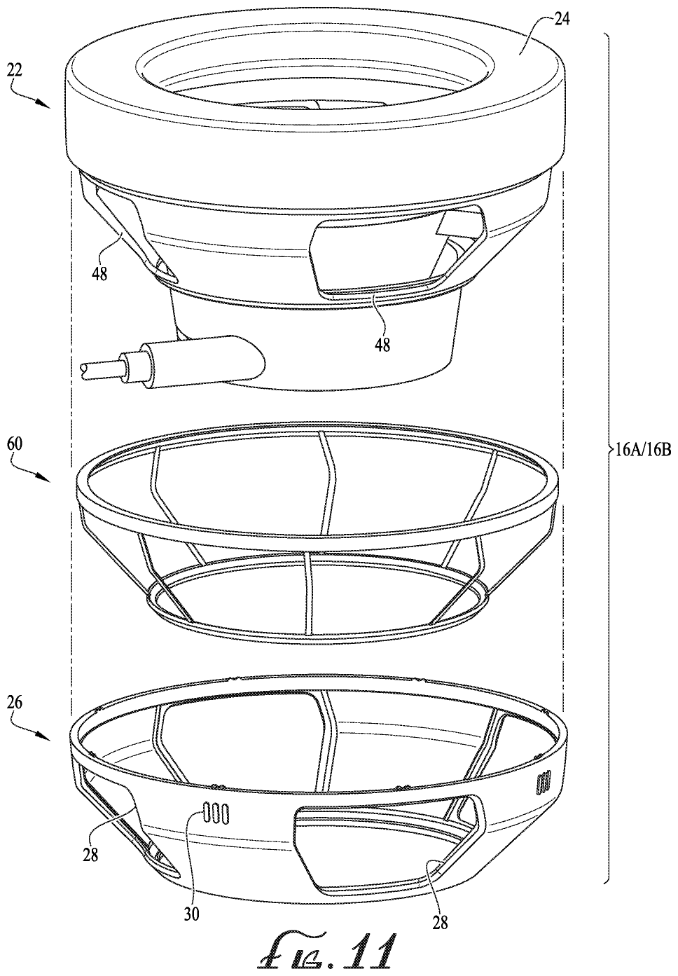

FIG. 11 is an exploded view showing the ear cup shell 22 with windows 48, an engagement portion 60, and the vent carrier 26 with vent windows 28 and grips 30. The engagement portion 60 can preferably be made of a low friction material that also slightly spaces the vent carrier 26 away from the ear cup shell 22 so that the vent carrier 26 can be moved relative to the ear cup shell 22. In this view, a portion of each of the ear cup shell 22, an engagement portion 60, and the vent carrier 26 is shown as being cut away to reveal the internal features.

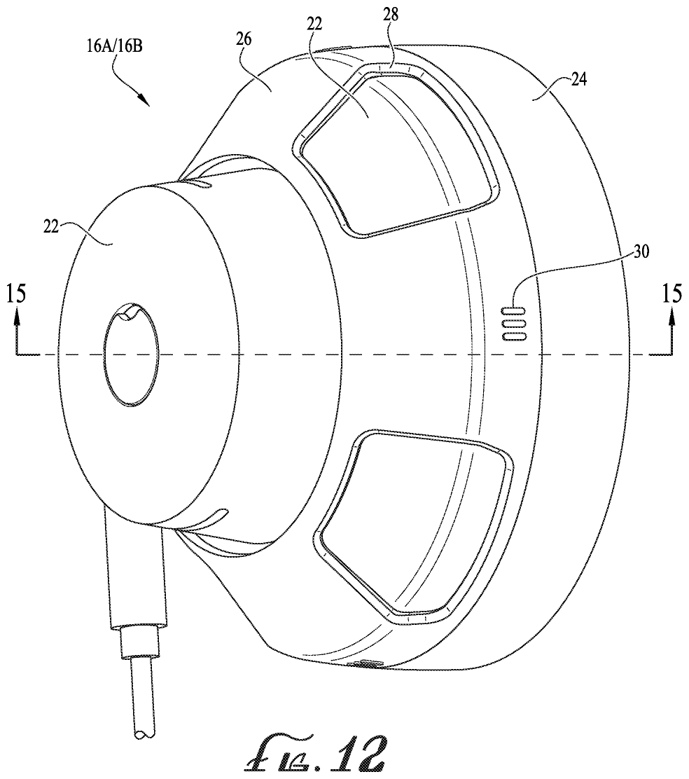

FIG. 12 is an isometric view showing an ear cup portion 16A/16B with its venting band 26 aligned so that its windows 28 are out of alignment with corresponding windows 48 (not shown) formed in the ear cup shell 22, which corresponds to the closed position.

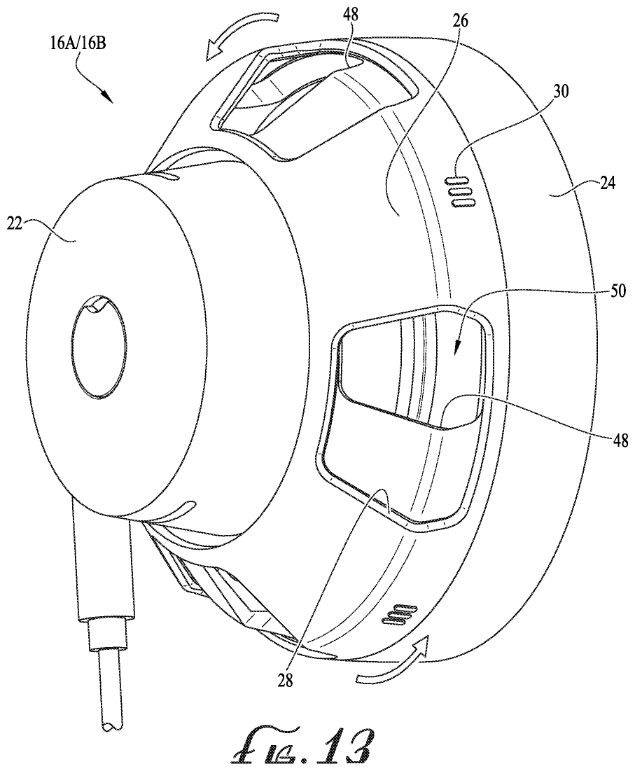

FIG. 13 is an isometric view showing an ear cup portion 16A/16B with its venting band 26 aligned so that its windows 28 are partially in alignment with corresponding windows 48 formed in the ear cup shell 22, which corresponds to the partially opened position of the windows 50.

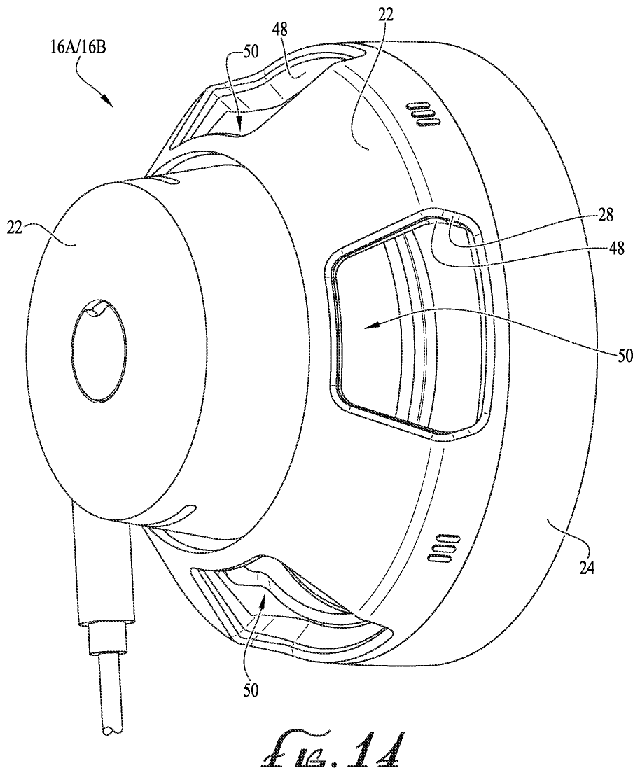

FIG. 14 is an isometric view showing an ear cup portion 16A/16B with its venting band 26 aligned so that its windows 28 are completely in alignment with corresponding windows 48 formed in the ear cup shell 22, which corresponds to the completely opened position of the windows 50.

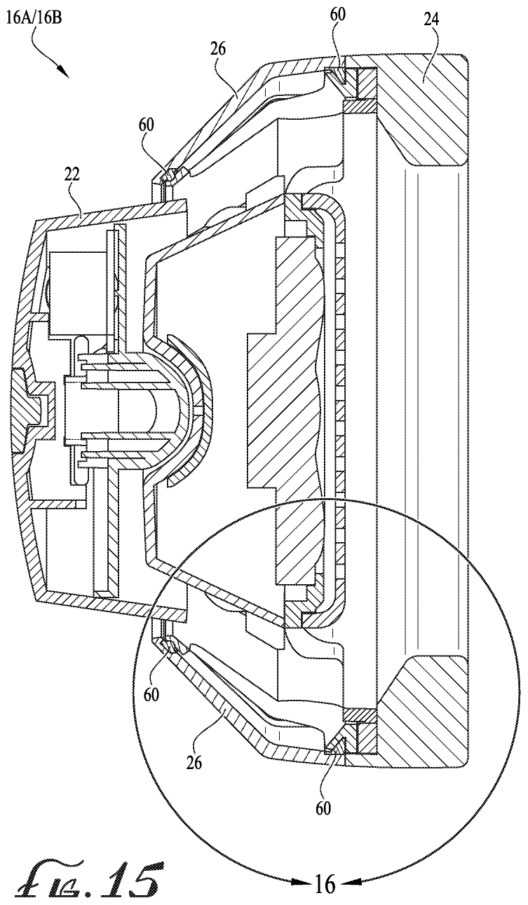

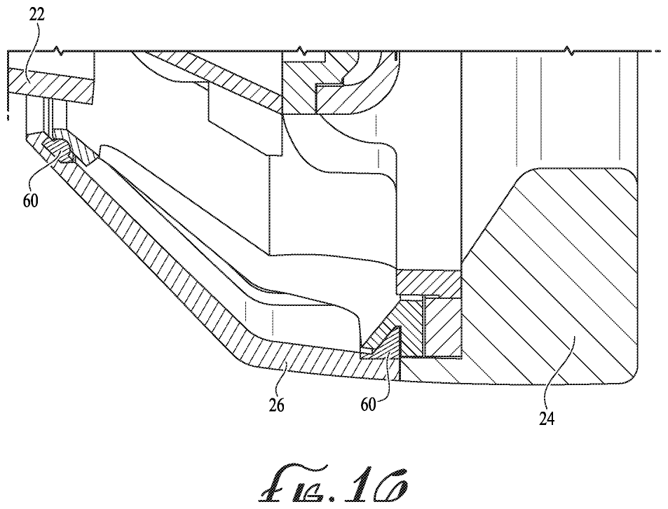

FIG. 15 is a cross sectional view through view lines 15-15 of FIG. 12 and shows how the engagement portion 60 engages with the ear cup shell 22 and the venting band 26 while allowing the venting band 26 to rotate relative to the ear cup shell 22, and also shows the ear cushion 24. FIG. 16 is a detail of the dashed circled area of FIG. 15 and shows this rotatable interconnection in larger scale. The engagement portion 60 is just one possible mechanism to accomplish this movability and other options are within the skill of those in the art. For example, instead of being rotatable relative to the ear cup shell 22, the vent carrier 26 instead can slide in and out to selectively open and close a window.

While this invention has been particularly shown and described with references to preferred embodiments thereof, it will be understood by those skilled in the art that various changes in form and details may be made therein without departing from the scope of the invention encompassed by the appended claims.

What is claimed is:

1. Full ear covering venting headphones, comprising:
a pair of ear cups, each ear cup comprising,
an ear cup shell portion with at least one venting window formed therein,
a vent carrier movably positioned relative to the ear cup shell portion, the vent carrier having at least one vent carrier window formed therein, the vent carrier being selectively movable between a closed position wherein the at least one vent carrier window of the vent carrier is out of alignment with the at least one venting window on the ear cup shell portion and thereby blocks the at least one venting window on the ear cup shell portion, and an opened position, wherein the at least one vent carrier window of the vent carrier is aligned with the at least one venting window on the ear cup shell portion and thereby unblocks and exposes the at least one venting window on the ear cup shell portion.

2. The full ear covering venting headphones of claim 1, wherein each of the ear cups further comprises a speaker.

3. The full ear covering venting headphones of claim 1, wherein each of the ear cups further comprises a head contacting cushion portion that seal the ear cups around the user's ears.

4. The full ear covering venting headphones of claim 1, further comprising a head band portion and a head band engaging portion for connecting each ear cup to the head band.

5. The full ear covering venting headphones of claim 4, wherein the head band portion includes a top portion that rests on the user's head and a pair of arms that engage downwardly therefrom, head band engaging portion of each ear cup being movably engages with the head band portion to allow each ear cup to selectively slide up or down relative to arms of the head band.

6. The full ear covering venting headphones of claim 4, wherein the head band portion further comprises comfort cushions.

7. Full ear covering venting audio headphones, comprising:
a head band portion; and
a pair of ear cups, each ear cup comprising,
a head band engagement for connecting each ear cup to the head band,
an ear cup shell portion with a plurality of venting window formed therein,
a head contacting cushion portion that seal the ear cups around the user's ears,
at least one speaker, and
a vent carrier rotatably positioned relative to the ear cup shell portion, the vent carrier having a plurality of windows formed therein, the vent carrier being selectively rotatable between a closed position wherein the plurality of vent carrier window of the vent carrier are out of alignment with the plurality of venting window on the ear cup shell portion to thereby block the plurality of venting window on the ear cup shell portion, and an opened position, wherein the plurality of vent carrier windows of the vent carrier are aligned with the plurality of venting windows on the ear cup shell portion to thereby unblock and expose the plurality of venting windows on the ear cup shell portion to allow air and sound to pass into the ear cup shells and to allow moisture and heat to better escape therefrom.

8. The full ear covering venting headphones of claim 7, wherein the head band portion comprises a top portion that rests on the user's head and a pair of arms that extends downwardly therefrom, the head band engagement of each ear cup being movably engaged with the head band portion to allow each ear cup to selectively slide up or down relative to arms of the head band.

9. The full ear covering venting headphones of claim 7, wherein the head band portion further comprises comfort cushions.
